(19) United States
(12) Patent Application Publication
(10) Pub. No.: US 2007/0172799 A1
(43) Pub. Date: Jul. 26, 2007

(54) Method for teaching verbs of foreign language

(76) Inventor: Christian Aubert, Los Angeles, CA (US)

Correspondence Address: GREENBERG & LIEBERMAN, LLC, 2141 WISCONSIN AVE, N.W., SUITE C-2, WASHINGTON, DC, 20007, US

(21) Appl. No.: 10/598,596

(22) PCT Filed: Mar. 2, 2004
(86) PCT No.: PCT/US04/06376

§ 371 Date: Sep. 5, 2006

(51) Int. Cl. G09B 19/06; G09B 19/08

(52) U.S. Cl. 434/157

(57) ABSTRACT

A method for teaching a foreign language and its verbs conjugations by focusing on understanding first and speaking second to help the student hear and say dialogs the real way natives speak. The student first listens to the conjugation or the text of the dialog read by the speaker the exact way it is generally spoken. The subsequent steps are organized with the idea that to learn well and fast, one needs to exercise each and all of his or her senses. The senses are taken separately and added one at a time. The hearing sense comes first, then the taste is added on top of it when the student is asked to repeat, then the sight when the students are asked to observe in the text what they are repeating. The sense of touch is then added when for the verbs they practice each tense vertically. The verb is the most important part of the sentence and as they practice the way on the verbs and by extension on entire dialogs, the student will learn to read the way people really speak, not the way they read.

### BACKGROUND

The present invention is a method and system for practicing a verb conjugation or a dialog focusing on understanding first and speaking second. It is an elaborate step-by-step approach aimed at dividing the senses in use so that all of them are exercised in the practice, which is conducted in a real speech environment.

Different methods of learning languages exist. All of them have their flaws for an important reason. Their main focus is on either writing (the classic academic approach) or speaking (all the other methods since Berlitz.)

Like it is explained clearly in patent U.S. Pat. No. 6,341,958 B1, invented by Zilberman, on Jan. 29, 2002, one of the difficulties is to not try to translate while you speak in a foreign language. The patent states that the traditional way of learning is the translation method with the strong use of analysis and applying grammar. It further mentions the other methods: the audio-lingual method, the direct method and the total immersion method. Their assertion that the classical method is notoriously inefficient is true. It is the most widespread method used in most schools and colleges. The audio-lingual method teaches through listening, speaking, reading and writing. This patent asserts that when you practice separately listening and speaking, you still translate. The direct method consists of associating words and phrases with objects and actions without the need of the native language. It is not for self study by adults, as it requires a teacher specially trained in this method.

The total immersion is the Berlitz method born in 1892 and is not good for self-teaching as it requests a trained teacher. People still translate. In U.S. Pat. No. 6,341,958 B1, by Zilberman, that patent also pretends that the reason why the immersion doesn't work is because as it has been shown, an adult of 30 years becomes fluent after 5 years of total immersion. Most people become discouraged way before that.

Finally there are additional audio-visual courses, which make extensive use of dialogues and teach through exercises and tests.

The method described in this patent U.S. Pat. No. 6,341,958 B1, Zilberman says that it achieves the simultaneous task of reading and repeating by exercising faster and faster. But this system requests that you read, and then repeat. If you read, the spelling influences you and this is one of the things that the present invention avoids. Their technique could actually be classified in what they call the direct method group.

According to the present invention the problem that the student encounters is not the speech but the understanding. The present invention notices that in none of these methods described above—including the last one, the problem of understanding is approached. The teacher or speaker reads the material that the student repeats and the method of present invention does that too, but the way most people (and teachers) read is very different than the way they speak. This has never been taken into account so far and that is what makes the method of the present invention so powerful. Usually, teachers or speakers have not been trained to read the way we speak, like the actor does. The language that is taught is therefore foreign to the one that is really spoken.

### SUMMARY OF THE INVENTION

Starting with the practice of verb conjugations and extending the method to the practice of dialogs from interviews, films, documentaries or ads, the method of the present invention is a tool provided to the students to make them understand real French conversations by natives, and to make these students speak like the mentioned natives. The present invention method achieves this goal by:
Using a presentation that is closer to the spoken language than the classic layout,
Using colors to show liaisons and what is and what is not pronounced in the spoken language, as well as the stressed syllables,
Making students repeat the verbs horizontally and vertically and later on making them repeat entire excerpts of conversations rather than words or sentences taken out of context,
Making people repeat following a step by step approach, at each step adding the use of one more sense at a time. The hearing sense is the first sense used, avoiding the pronunciation to be influenced by the spelling,
Explaining in every lesson the rules of speech, which differs from language to language.

With the help of the present invention, the student will acquire an ability to understand a foreign language that seems to be spoken too fast and through that understanding gain an enhanced confidence in the art of speaking into the foreign language studied, and consequently communicate.

The student will learn directly from the natives instead of listening to a dialogue that has been first written down.

The method of the present invention is comprised of:

Providing a presentation of verbs conjugations, and excerpts of dialogs recorded during an interview or taken from a movie, TV show, documentary or commercial in a foreign language;

Providing the transcript of these excerpts with the translation. The original presentation of the verbs and the transcript of the dialogs are written with colors to show what is and what is not pronounced in the foreign language;

Providing recorded lessons with different steps to practice the verbs and the foreign language using the senses added one at a time.

During the last step of repetition, providing instructions how to recognize the differences between the written material and the spoken material in order to achieve the learning of reading the way the language is really spoken. Each language has rules of speech that have not been written down yet. In the present invention the rules have been written down for the French language.

The entire approach and system of the present invention may be implemented via the use of the books, CDs, Cassettes, DVDs, MP3, but also via a computer-aided system having an audio output device, a processor, and display having a display screen. The computer-aided system operates by:

Providing a verb conjugation written horizontally as explained in the description there after.

Providing a digital audio and video recording of the lesson in the studied foreign language. The audio and the sound of the video are played through the audio output device;

Providing a layout of the lesson with the steps and at each step instructions to go through that specific step;

Providing a transcript of the dialog that can be appearing on the display together with the screen of the video or the button of the audio;

Providing a digital recording of the lesson divided into steps to repeat without reading, then with reading;

Providing a step of repetition with recorded instructions describing the rules of speech of the studied language.

Providing a booklet with the dialogs and their translation, the dialogs being written with colors.

The following description will make it clear to a person exercised in the art of speaking that the present invention brings the teaching of foreign language to a superior level.

### BRIEF DESCRIPTION OF THE DRAWINGS

Novel features and advantages of the present invention, in addition to those mentioned above, will become apparent to those skilled in the art from a reading of the following detailed description in conjunction with the accompanying drawings where in similar reference characters refer to similar parts and in which:

FIG. 1 and FIG. 2 is a visual that depicts respectively the straight movement and the oscillating movement made by the student when he practices the first person singular and its corresponding plural of the vertical exercise of the verb conjugation as described hereunder. This will be included on one of the pages of the textbooks.

FIG. 3 shows the introduction page of the present invention computer program in case of a dialog, with a screen, which can play the introduction to the program. Aligned are photos of guests or posters. The student clicks on a photo or on a poster to start a lesson.

FIG. 4 shows the view of the first page from the computer program of any step of a sample lesson in which instructions are in the middle, with buttons to go to the following steps on the left of the screen, and buttons to go to other pages to listen to the recorded audio and video and to open the translation or the dialog in the studied language according to the present invention, on the right of the screen.

FIG. 5 shows the layout from one step of a lesson from the computer program with the text of the dialog open. It features the audio button to play the recorded step of the lesson.

FIG. 6 shows the video [from the computer program] of the interview or scene with the transcript above it to follow the dialog.

### DETAIL DESCRIPTION OF PREFERRED EMBODIMENT(S)

The present invention is a method, system and computer program for practicing foreign language verb conjugations and learning the foreign language by dialog focusing on understanding first and speaking second.

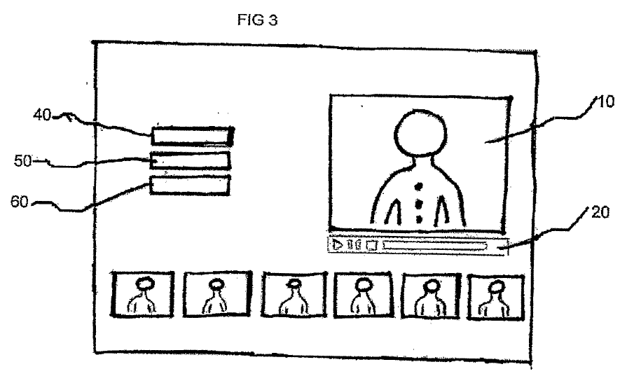

The method of the present invention will be taught live in the classroom and will also be available on CD-ROMs, CDs, Tapes, DVD as well as on the Internet. The computer program on CD-ROM, CDs, Tapes, DVD and on the Internet will have the introduction page 10 as shown in FIG. 3. The screen 15 will feature an introduction page 10, which will play an introduction to the program by a speaker. The controls window 20 below the window 70 will control the audio and the video features of the computer program. The controls window 20 will feature a series of buttons to be clicked in order to start, pause, stop and control any other functions of the computer program or the video from the either the tapes or DVD. To enter the computer program, the student will click on one of the photos 30 or posters 35 at the bottom of the screen 15. On the left of the screen 15, there are buttons 40, 50, and 60 to go to any levels of instruction, Beginner 40, Intermediate 50, and Advanced 60.

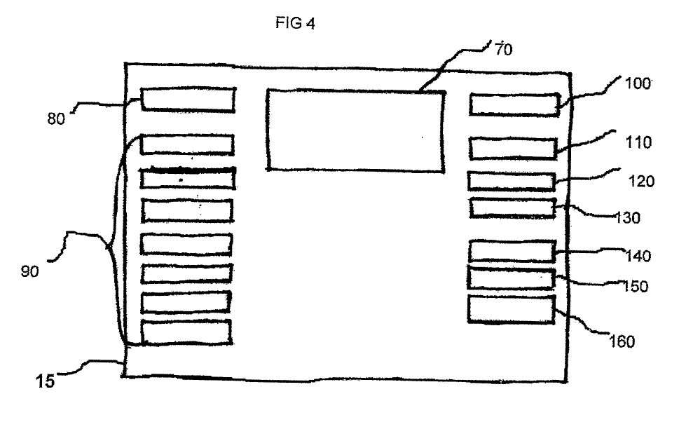

On FIG. 4 the screen 15 features a square in the center, which represents the window 70, where the written instructions for the current step of any particular lesson. In the left upper hand corner of the screen 15 appears the name of the guest window 80 [or the name of the film] corresponding to the text that the student has chosen to work on. Below the name are all the buttons for the steps of the lesson 90, which the student can choose to access at any moment during the lesson. On the other side of the screen 15, a “menu” button 100 allows the student to go back to the page featuring the introduction page 10 as shown in FIG. 3. Below this menu button 100 a group of three buttons, 110, 120, and 130 that give a choice to the student to open the text of the translation 110, the text of the dialog 120 in the studied language or the text of the dialog in the studied language with its translation underneath 130. The next group of three buttons 140, 150 and 160 features the possibility of opening a page to see the video of the conversation or the text with its translation underneath 130, the video with space for the text 150 or to open the button allowing the student to hear the audio of the conversation only 160.

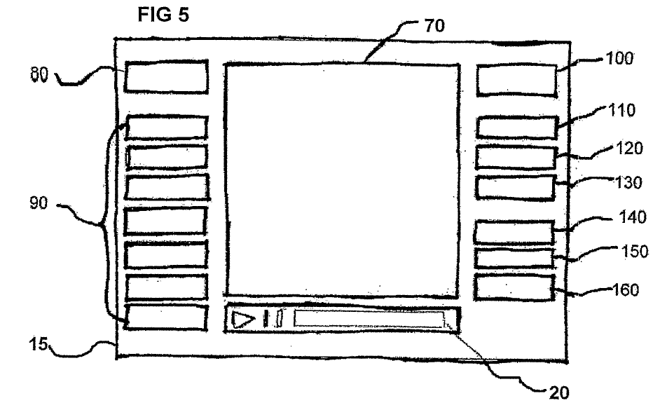

FIG. 5 shows the same window 70 from the computer program features on FIG. 4 with the exception that it shows it the way it looks like when the text of the dialog 120 or the text with its translation underneath 130 or the translation 110 are displayed in the window 70 of the screen 15. The controls window 20 is featured under the window 70 containing the text.

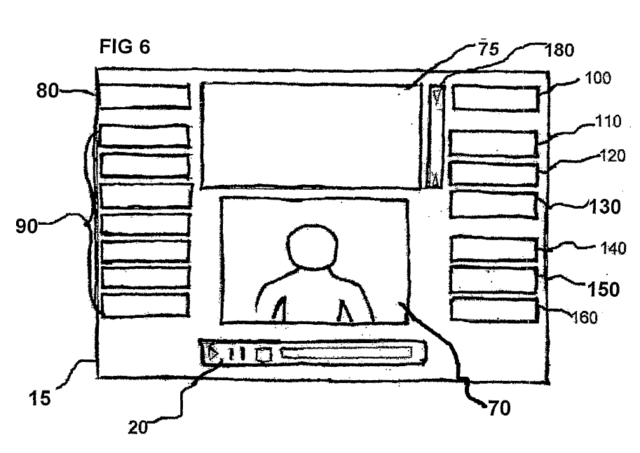

FIG. 6 shows the screen 15, showing the window 70, featured with the video of the conversation or 150 with the text of the translation 110, the text of the dialog 110, 120, 130 in the studied language, or the text of the dialog in the studied language with its translation underneath 130, above it in another window 75. A scrolling control window 180 is located on the screen 15 for the text of the dialog 110, 120, 130 to go up and down at will. A scrolling control window 180 is located on the window 75 for the text of the dialog 120.

A typical lesson following the present invention is conducted this way:

Step 1: Students may familiarize themselves with the translation of the verb and its tenses, and the translations of the dialogs. Later they will lose the need to read the translation. Therefore this first step is optional.

Step 2: They will listen to the verb or to the text of the conversation read by the teacher. The verbs are read the way they are generally spoken in a middle of a conversation. The text of the conversation is read exactly the way it was delivered in the corresponding recording. It is better to avoid reading the transcript at this step but the beginner might feel uncomfortable if he or she doesn't have the text in front of him or her. Therefore, it is available. Later on the students will lose the craving to read the transcript at this step.

Step 3: Now the students repeat. They are asked to concentrate on what they hear. The transcript is available but the best way is still to just listen.

Step 4: Now they are asked specifically to look at the verb table or at the text in the native language. They still need to concentrate on what they hear, and repeat.

Step 5: Their attention is on the text. They repeat again and the rules of speech are explained. When we speak, there are things that we do with the words and their delivery. A pattern of habits can be observed and these habits can be written into rules. These rules help us read the way most people speak most of the time. To give an example, these are the . . .

### Rules of Speech for the French Spoken Language

Lots of letters are not pronounced in French. It happens mostly at the end of words. These letters are called “Silent letters”. New students are made aware of them at the very beginning of their French classes. But there are other circumstances in spoken French where vowels, consonants, or even entire words are not pronounced. These are due to contractions that people do when they speak. Most French people are not aware of the way they contract or the frequency of their contractions.

1. The Vowel “e”

Generally, the syllable containing the vowel “e” is contracted in the spoken French language when that syllable is following a vowel sound. It happens a lot for one-syllable words like “je”, “te”, “me” etc. . . as well as for multi-syllable words. For example, “maintenant” is pronounced “maintnant” and “Café de Paris” is pronounced “Caféd Paris”.

2. The Case of the “je”

The word “je”—“I” in English, is often starting a sentence. Therefore it doesn't necessarily follow a vowel sound. But even in this case, it is often contracted. For example: “Je vais aller a la poste” will be said “Jvais aller a la poste”.

3. Il y a

The expression “il y a” is often reduced to “ya” in spoken French. Also, “il y en a” will sound “Y en a”.

4. The Negation

As you will notice if you observe the way French natives speak, the “ne” which indicates the negation in association with “pas”, “plus”, etc. . . is regularly omitted.

5. The Case of “Tu”

Going through the real dialogues, you will notice that the “u” of “tu” (“You” in English) is often dropped when it's followed by a vowel. “Tu as” becomes “Ta”, “Tu es” becomes “Tes”, etc. . .

6. Eh bien

The expression “Eh bien” will be reduced to “Eh ben” or even “Ben” most of the time.

7. “Il”

The “l” of the pronoun “il” is often silent when “il” precedes a consonant. Likewise, “elle” is often reduced to “e” in front of a consonant. For example “Il parle” will sound “I parle” (ee parl) and “elle parle” will sound “e parl”

8. The Pronoun “on”

“On” is most of the time used for “We” in spoken French, instead of “Nous”

9. The Endings “Tre”, Gre”, “Vre”, etc. . .

When a word ends with these sounds, the “re” part of it is droped in front of a consonant most of the time.

10. “euh”

When French people are looking for their words, they often say “euh”. Such particularities occur in all languages and our claims are for all languages.

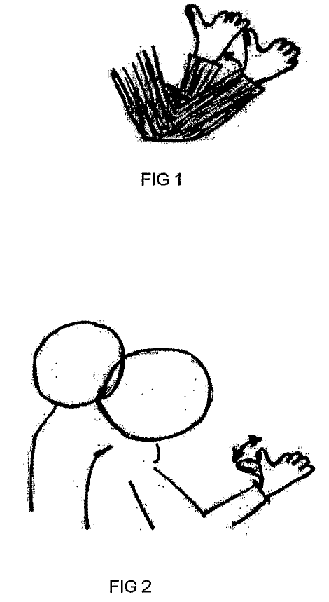

Step 6: So far, for the verbs, these have been studied following their horizontal presentation. At this next step, the students work, following the vertical presentation, using the movement. For the dialogs, they can now listen to the real dialog by clicking on audio only or they can see the video of the conversation. Later on we suggest that they try to talk along with the characters on the screen. For the verbs, the students will use the movements—the sense of Touch, described on FIG. 1 and FIG. 2. FIG. 1 shows the arm describing a straight movement when the student indicates himself when he says “Je parle”. Then the student makes an oscillated movement (FIG. 2) from the thumb when he says “On parle”—We speak”. Similar movements occur for the second and the third person. The singular initiates a straight move from the thumb (for the first person—“Je”—“I”) or the finger (for the second or the third person (“Tu”—“You” and “Il”—“He”). The plural initiates an oscillating movement from the thumb or the finger. For the second person, the student uses the finger to point to the other person or persons, while saying: “Tu parles”—You speak”. The plural initiates the oscillating movement from the finger while the student, pointing to two or more says: “Vous parlez”—“You speak”. For the third person, it's the same thing except for the fact that the student is talking to someone about somebody else (Singular) or about others (Plural). Speaking to someone and pointing straight to somebody else, he says: “Il parle”—“He speaks”. Then pointing to several people with the oscillating movement he says to someone: “Ils parlent”—“They speak”.

Step 7: Only for the dialogs, they are reminded of two sentences or expressions and their meaning. They repeat in order to be able to use them in any conversation. Step 6 and 7 are interchangeable.

In the case of dialogs, a typical lesson at the advanced level is conducted in a very similar way except for the fact that on Step 1 you listen directly to the real dialog and then you go to step 2 and repeat right away. The repetition is conducted a lot faster.

The practice of the conjugation of verbs is enhanced by its presentation itself. Those who are familiar with the classic presentation of verb conjugations will see big differences in our presentation. It's mainly due to the fact that our focus is on making the student understand and speak the way natives do. The conjugations are written with colors to show contractions, liaisons and stresses. The first noticeable difference with the classic approach is the horizontal presentation. The students read the verbs horizontally, the way they read novels or newspapers. There are two lines, one for the singular and one for the plural. For example, the verb “Parler” will be shown in two lines. The first line will feature the singular: “Je parle, tu parles, il parle”. The second line will feature the plural: “On parle, Vous parlez, Ils parlent”, “On parle” being placed exactly under its corresponding singular “Je parles”, “Vous parlez” being placed under its corresponding singular “Tu parles” and “Ils parlent” being placed under its corresponding singular “Il parle”. In order to show what is not pronounced when we speak, in “Je parle”, the two “e” letters are both in red, the “es” at the end of “Tu parles” is in red, the “I” of “Il” and the “e” of “Il parle are in red, the “e” of “On parle” is in red, the “s” of “Vous” is in red, the “Is” and the “ent” of “Ils parlent” are in red.

Another huge difference in the French version consists in placing the “on” form as the translation of “we”, under the “je”. “We” is not the translation of “on”, which means “one”. It's the concept of it. French people use “on” most of the time to say “we”. That is why we put it there in the table. Unlike on our general original presentation, this showing of the“On” had never been done before us. Like in English, “On” agrees at the third person, like “il” (he speaks—one speaks). Similar misplacements occur in Spanish with “Usted” and “Ustedes”.

The conjugation tables are practiced first with our repetition technique described above. As it is presented horizontally, we make the student listen, repeat and read. The first line is worked on first and represents the singular. The second line is then practiced. The advantage of this exercise is to notice what is rarely noticeable, that in regard to the sound, the verb doesn't change depending on the subject and is therefore easily assimilated. Only the “vous” form takes a different sound. The feeling of easiness comes also from the fact that we use the “on” form at the place where the “nous” form used to be, as it is common practice in spoken French to use “On” instead of “Nous” to mean “We”. We have noticed for the Spanish conjugation that when our form is applied, there is immediate noticeable connection between the singular and the corresponding plural through the sounds. This is not noticeable in the traditional form.

The training of verbs continues with the vertical exploration of this horizontal presentation. Using their thumb and fingers to show what the subject represents, the students express the singular first person and its corresponding plural, the second person and its corresponding plural and the third person and it's corresponding plural. The advantage of this practice is to really observe that in each plural, the corresponding singular is included. In the “on” concept, the “je” is included, in the “vous” plural, the “tu” is included and in the “ils” concept, the “il” singular is included. The student has the feeling to grab the language, to touch it.

Again, the major advantage of this presentation is that the plural of each subject is placed right under the singular. The student can then practice vertically saying the “I” form with a straight movement of the thumb as they point to themselves, then the “We” form, which includes the concept of the “I”, as they move their thumb in order to point to themselves and another person close to them, imagined or real. The same way they say the “you” singular, then the “you” plural. In English these two forms are the same but in French and Spanish for example, they are different. And they say the “He” form and the “They” form, which includes the concept of the “He”.

The students have listened to the verbs, repeated them, read them and expressed them with movements. Using all their senses, the presentation and the practice of the present invention will increase the memory and the confidence.

Practicing the lessons of the present invention the way it has just been described allows the student to get acquainted little by little with the verbs and especially with the little words that methods generally never focus on but which link every thing in forming the body of the language. The vocabulary comes afterward when the student has been trained to listen to a global conversation that is a real one. This step-by-step methodic approach will enhance the feeling of comfort and the confidence in the student as no memorization is ever requested or expected. The vocabulary is acquired easily as it is simply practiced in the case of the verbs and observed in the case of other words in the context of the conversation. It is approached through listening, then speaking, then reading, the pronunciation being worked on prior to the reading, making the influence of the spelling of the words impossible. By contrast to any other method, the method of the present invention defines the practice of the verbs and the foreign language the way it is really spoken. The dialogs are live conversations or taken from films, where actors know how to render a written dialogue like it has been improvised.

I claim:

1. A method of teaching verbs, and a foreign language in general, focused on understanding first and speaking second to help the student hear and say dialogs the real way natives speak and comprising the steps of:
listening to the foreign language as spoken by natives without looking at a transcript; and
pronouncing words and sentences in context, by showing the liaisons, contractions and stresses.

2. The method of claim 1, further comprising:
practicing verb conjugation using the same repetition technique as used with dialogs, along with a horizontal presentation to focus the attention on the sounds rather than on the writing of these verbs, and which places the corresponding plural under its singular, using colors for liaisons, contractions and stresses in the approach,
listening to transcripts of real conversations recorded live through interviews or taken from TV shows, documentaries or commercials or movie excerpts; and
teaching rules of speech explaining the liaisons, contractions and stresses, which mark the difference between the reading and the speech level.

3. The method of claim 1, further comprising:
using a computer display to provide motivational messages to a student to use learning material fully to the student's advantage.

4. The method of claim 1, further comprising:
using a computer for listening to a recorded lesson in which the student listens; listens and repeats; listens and repeats while observing in text the difference between the reading and the speech level; listens, repeats, and reads receiving instruction about the rules of the spoken language.

5. The method of claim 4, further comprising practicing verbs with movements.

6. The method of claim 1, further comprising:
displaying a verb conjugation in its new form to teach the student how to practice the conjugation with the new invention;
displaying photos of the interviewees or posters of films on which the student can click to enter the lesson;
displaying the verbs and the texts with colors to indicate the liaisons, contractions and stresses of the language studied; and
displaying the transcript together with the translation to facilitate the access to the latter.
